(19) United States
(12) Patent Application Publication
(10) Pub. No.: US 2002/0156678 A1
(43) Pub. Date: Oct. 24, 2002

(54) Internet-based newspaper publishing franchise

(76) Inventor: Vincent Lee Adams, Gardendale, AL (US)

Correspondence Address: LANIER FORD SHAVER & PAYNE, P O BOX 2087, HUNTSVILLE, AL, 35804, US

(21) Appl. No.: 09/837,033

(22) Filed: Apr. 18, 2001

(51) Int. Cl. G06F 17/60

(52) U.S. Cl. 705/14; 705/1

(57) ABSTRACT

A network-based newspaper franchise system and method providing a Franchisee a website, a publication engine, publishing and sales training modules, a revenue reporting module, and hosting/service support over a communications network whereby an individual can publish a newspaper on a website over a communications system and generate revenues.

### BACKGROUND OF THE INVENTION

1. Field of the Invention

The present invention relates to Internet franchising methods and, particularly, to methods and systems for newspaper publishing franchises.

2. Background of the Invention

The local community newspaper is a long-established element of the every-day necessities of American life. Most towns or communities have only one or, perhaps two, newspapers that cover local and national news, community affairs, school events, sports, business, advertisements, classified ads, obituaries, etc. For all practical purposes, the town newspaper functions as an unregulated monopoly or quasi-monopoly. The local newspaper essentially has little competition and can provide whatever information it chooses to the reader. This lack of competition is not desirable for the newspaper publishing industry or for society as a whole. Competition drives the economy, creates jobs, increases performance, lowers costs, and creates a better product.

There are two major barriers to competition in the newspaper publishing industry: 1) the cost of entry into the market, and 2) the perception that one newspaper in a community is sufficient. The cost of equipment, labor, and inventory alone is a sufficient barrier for a single individual to start and sustain such a business. In addition, profit margins are low because of the extensive overhead to maintain a traditional newspaper publishing business.

The Internet has recently been a vehicle for the publication of newspapers. More than 400 newspapers have established a presence on the World Wide Web. About 75 percent have classified advertising and selling-ads on the web. The Internet is used to exchange significant amounts of information electronically around the world. It has provided access and exchange of information among government agencies, laboratories, universities, and businesses. Today, individuals have access to the Internet from their homes. The Internet is considered a new marketplace for various goods and services and there are numerous ways of transacting buying and selling over the Internet. The Internet is particularly suited for the purchase and sale of information. Information products can be delivered electronically, there is little cost for manufacturing and inventory, and processing a buyer's order can be automated.

The Internet is a global network of computers with networks branching from the core. These branches, in turn, have networks branching from them, and so on. Routers move information packets from network to network, until the information packets reach their destination. One popular part of the Internet is the World Wide Web. The World Wide Web contains computers which display graphical and textual information. Computers which provide information on the World Wide Web are typically called “websites.” A website is defined by an Internet address which has an associated electronic page, often called a “home page.” Generally, a home page is an electronic document which organizes the presentation of text, graphical images, audio, and video into a desired display. These websites are operated by a wide variety of entities which are typically called “content providers.”

A user may access the Internet using any Internet accessing device equipped with a conventional modem. Special interface software is installed within the Internet access device so that when the user wishes to access the Internet, an attached modem is automatically instructed to dial the telephone number associated with the local Internet host server. The user can then access information at any website address accessible over the Internet. The Internet can be accessed by any kind of computer and other devices, such as, for example, cell phones, palm pilots, web-TVs and the like. There are other transmission means besides phone lines and modems. There are expected to be more transmission means in the future, including wireless, satellite, and cable technologies, and the like. The present invention is not limited in any way by the Internet transmission means.

Information exchanged over the Internet is typically encoded in Hyper Text Mark-up Language (HTML) format. The HTML format is a scripting language which is used to generate the home pages for different content providers. A content provider is an individual or company that places information (content) on the Internet so that it can be accessed by others. A HTML document can also include hyper-links which allow a user to move from one document to another document on the Internet. A hyper-link is an underlined or otherwise emphasized portion of text which, when selected using an input device such as a mouse, activates a software connection module which allows the user to jump between documents, i.e., within the same website or to other website. The Internet and the World Wide Web, together with other interactive devices, are used widely to share information among different users.

In theory, the Internet may offer any individual a practical mechanism to create his or her own newspaper publishing business. The newspaper could be national and/or local. Newspapers derive income from advertising, and the market is massive, with retail advertising in excess of $20 billion and classified ads in excess of $18 billion. Individuals publishing newspapers on the Internet should be able to reduce raw material cost to the extent that people desire the newspaper on their screen rather than on newsprint, with the option of printing any article on an inexpensive printer. They will be able to sell access to the newspaper and generally increase both advertising and circulation revenue if the quality of their products is competitive. Indeed, there is no better platform for launching, promoting, co-branding, and joint selling with Internet sites than an authoritative newspaper. In this regard there is a need for a method and system to facilitate an individual's effort to create and implement an Internet newspaper publishing business.

Over the past forty years, the franchise business model has been highly successful and today more than 8 million people are employed by franchise establishments. Franchised businesses accounted for $803 billion in annual sales in 1992, accounting for 35% of total U.S. retail sales. Franchising is a form of licensing by which the owner (the Franchisor) of a product, service, or method obtains distribution through affiliated dealers (the Franchisee). A franchised business usually involves less risk than a wholly-owned business because the Franchisor provides a proven system to create and operate the business in an established, effective manner, and further provides a support team to teach and to provide the Franchisee consultation and advice as needed to effectively operate the business. The present invention provides a system and method for franchising an Internet-based newspaper publishing business.

### SUMMARY OF THE INVENTION

The present invention is a system and method for franchising a newspaper publishing business. The Franchisor provides a server/host through which the Franchisor and Franchisee communicate using the Internet. When a Franchisee purchases a franchise from the Franchisor, the Franchisor creates a newspaper publishing website for the Franchisee and provides a Content Management Application (CMA) to the website. The CMA functions as a virtual printing press. The Franchisor also provides a training system through the server/host which includes training in the use of the CMA to create a newspaper, and training in the sale of advertisements and services. The Franchisor further provides, through the host/server, access to national advertisers and national classified ads. The website is then supported, maintained, and upgraded by the Franchisor through the host/server. The Franchisee gathers content for the newspaper publication, sells advertising and services, and then publishes or posts the newspaper on the website. The Franchisee also reports revenue through the website and can make franchise payments to the Franchisor through the website and host/server. Thus, the Franchisee can independently publish his or her own newspaper on the Internet free from any and all technical constraints.

### BRIEF DESCRIPTION OF THE DRAWINGS

FIG. 1 shows the relationship among the Franchisor's computer and server, the Franchisor's website, the Franchisee's computer, and the Franchisee's website.

FIG. 2 shows Franchising applications and modules within the Franchisor's computer.

FIG. 3 shows the database elements of the Content Management Application.

FIGS. 4a-4j shows the components of the database elements within the Content Management Application.

FIG. 5 illustrates the Internet-based Newspaper Publishing Franchise system.

FIG. 6 illustrates the method of implementing an Internet-based Newspaper Publishing Franchise.

FIG. 7 shows revenue generating activities of the Franchisee and revenues to Franchisor.

FIG. 8 shows an example of a website page of a Franchisee's website depicting a newspaper publication.

### DETAIL DESCRIPTION OF THE PREFERRED EMBODIMENTS

While the following description details the preferred embodiments of the present invention, it is to be understood that the invention is not limited in its application to the details of construction and arrangement of parts illustrated in the accompanying drawings, since the invention is capable of other embodiments and of being practiced in various ways.

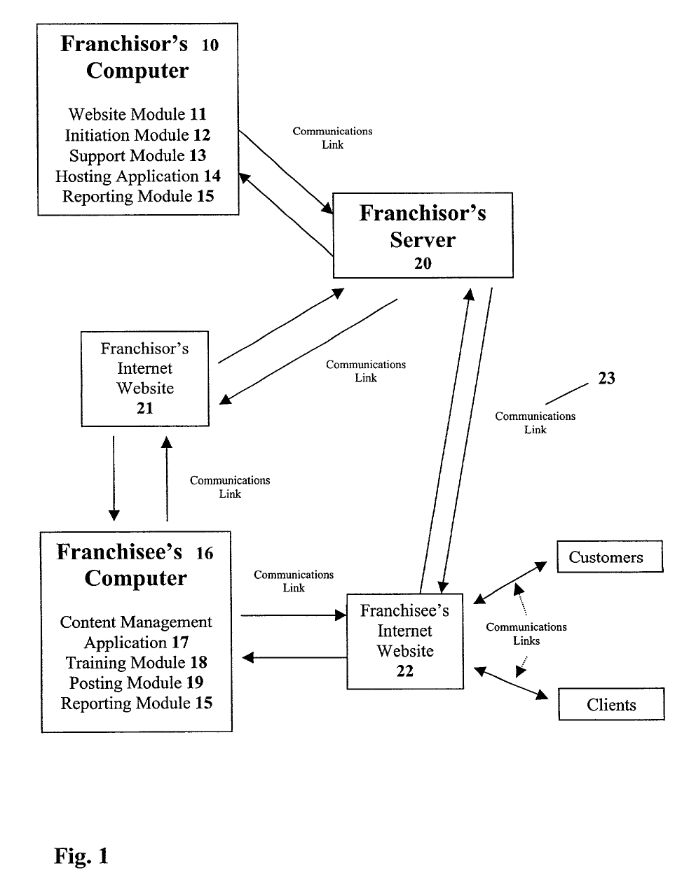

FIG. 1 shows a typical arrangement of computers and communication links to implement the Internet-based Newspaper Publishing Franchise system of the present invention. In a preferred embodiment of the present invention, the Franchisor's computer 10 contains a website module 11, an initiation module 12, a support module 13, a hosting application 14, and a reporting module 15. The Franchisee's computer 16 contains Content Management Application 17, Training module 18, posting module 19, and reporting module 15, provided by Franchisor's computer 10 through server 20 and communications link (system) 23.

The Franchisor maintains a server 20 which is in communication by means of communications link/system or network 23 with the Franchisor's computer 10, the Franchisor's Internet website 21, Franchisee's computer 16, and Franchisee's Internet website 22. Communication is maintained through communication link 23. A preferred embodiment of communications link, system, or network 23 is the Internet, but it could be a telephone line, an antenna, a satellite, a gateway, or any other type of communication link, system, or network. In general, a server 20 is a computer program that provides services to other computer programs in the same or other computers. In the client/server programming model, a server is a program that awaits and fulfills requests from client programs. A server 20 is one half of the client-server protocol that runs on a networked computer and responds to requests submitted by the client. The World Wide Web browser is a client of a World Wide Web server.

Although computers 10, 16 use WINDOWS 95, 98, or NT in a preferred embodiment, computers 10, 16 are adapted to execute any of the well-known operating systems, such as WINDOWS.TM, X-WINDOWS, MSDOS, PCDOCS, OS2, UNIX, MOTIF, MAC-OS. Computers 10, 16 comprise a processor, random access memory (RAM), read only memory (ROM), a mouse, a keyboard, a printer, disk drives, a display, and a communications application, all well known in the art. Computer software for the modules and applications of the present invention may be stored in RAM, ROM, or disk drives and may be executed by the processor as is known in the art. Communications applications are connected to communications link 23. Disk drives may include a variety of storage media such as, for example, floppy disk drives, hard disk drives, CD ROM drives, DVD drives, or magnetic tape drives. Although one type of common computer system has been described, other types of computers with various types of peripherals and memory applications could be used without departing from the scope of the invention.

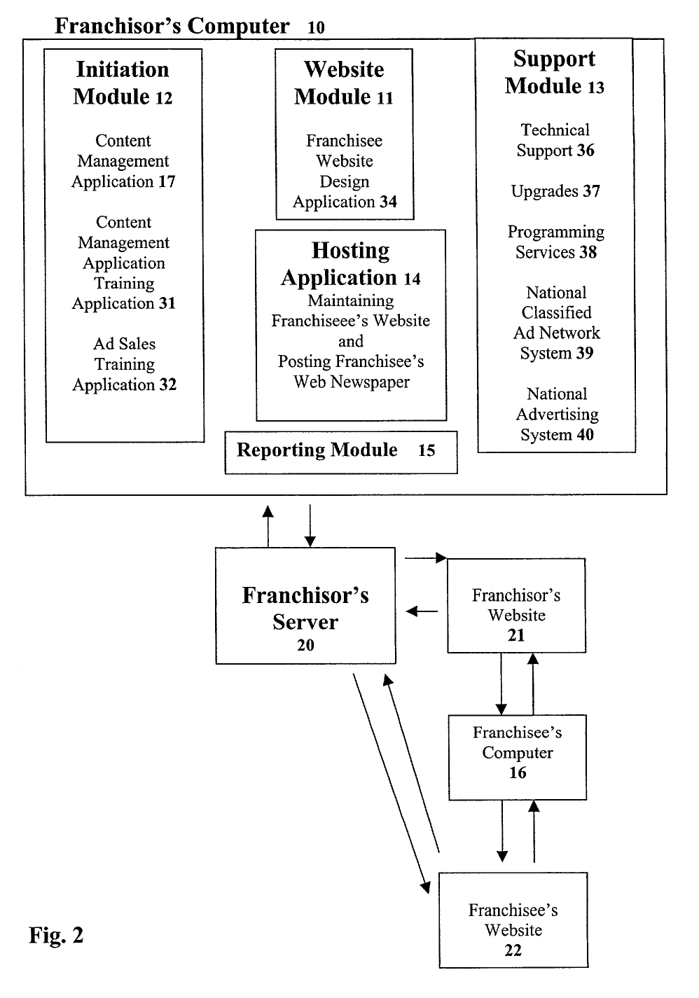

FIG. 2 shows more details of Franchisor's computer 10 regarding the applications and modules for creating and maintaining the Internet-based Newspaper Publishing Franchise of the present invention. The initiation software module 12 contains several software applications including Content Management application 17, Content Management Application training application 31, and a sales training application 13. Website module 11 contains Franchisee website design application 34. Support module 13 provides software for technical support 36, upgrades 37, programming services 38, national classified ad network system 39, and national advertising system 40. Hosting application 14 completes and maintains the posting of the Franchisee's web newspaper on the Franchisee's website 22 via the Franchisor's server 20. Reporting module 15 allows the Franchisee to report sales and make payments to the Franchisor via Franchisee's server 20 or Franchisor website 21. Server 20 can communicate directly with Franchisee's website 22 or through the Franchisor's website 21 and Franchisee's computer 16.

A Content Management Application is part of a Content Management System. The Content Management System also includes a Content Delivery Application. A Content Management System is used to manage the content of a website. The Content Management Application element allows the content manager or author, who may not know Hypertext Markup Language (HTML), to manage the creation, modification, and removal of content from a website without needing the expertise of a Webmaster. The Content Delivery Application element uses and compiles that information to update the Website. The features of a Content Management System vary, but most include Web-based publishing, format management, revision control, and indexing, search, and retrieval. The Web-based publishing feature allows individuals to use a template or a set of templates, as well as wizards and other tools to create or modify Web content. The format management feature allows documents including legacy electronic documents and scanned paper documents to be formatted into HTML or Portable Document Format (PDF) for the Website. The revisions control feature allows content to be updated to a newer version or restored to a previous version. Revision control also tracks any changes made to files by individuals. An additional feature is indexing, search, and retrieval. A Content Management System indexes all data within an organization. Individuals can then search for data using keywords, which the Content Management System retrieves.

The Content Management Application 17 of the present invention operates within a Content Management System, and enables the deployment of functionality across a communication line such as the Internet, using browser-based tools or user-friendly methods and procedures. Many Content Management Applications are well-known and can address four essential elements in a website: 1) Look and Feel—both technical and non-technical users can create the look and feel of a website with these Content Management Applications; 2) Functionality—these applications can create site functionality in minutes, such as, for example, shopping carts, calendars, announcement boards, chat rooms, and business directories. These Applications can be used as is off the shelf or they can be modified with the code provided; 3) Architecture—these applications allow a user to create a website's navigation bars and links in a matter of minutes. Non-programmers can change and update page links with the touch of a button without affecting the site navigation system. Complicated site navigation and linking tasks can be completed and updated in a few minutes; and 4) Content—a user can add, delete, edit, and manage content at will regardless of technical skill. The user can easily import copy from any application such as Word or any other generally accepted word processor or standard news room editor. Furthermore, a user can type copy directly into a built-in editor and update page content quickly and easily with the built-in edit contained in these applications. A user can also import graphics and place the graphics within copy simply through drag and drop functionality or other standard means, and can cut and paste pre-existing website pages.

Some of these Content Management Applications are developed in robust programming languages such as, for example, PERL, ASP, PHP, XML, etc., or even in a wireless protocol language for wireless capabilities. Some examples of such Content Management Applications that are currently in the market place include, for example, Terra-axis, Media Surface, Open Pages, Reedy Cheek Technologies, Info Office, Gauss Interprise, Atticus Scribe, WebExpress, Wheel House, Dyna Base, EGrant, and Red Dot.

The Content Management Application of the present invention is, essentially, the printing press, provided by the Franchisor. The Franchisor also provides the customized design and layout of the website, and the dynamic features and functionality of the website. These provisions allow the Franchisee to post, delete, edit, and manage the content of the Franchisee's website by the Franchisee locally. As a Franchisee investigates, gathers content, and reports the content (news) locally on his or her website, the Franchisee is able to generate local advertisement and service sales and thereby, compete directly with the established, local, traditional hard copy newspaper.

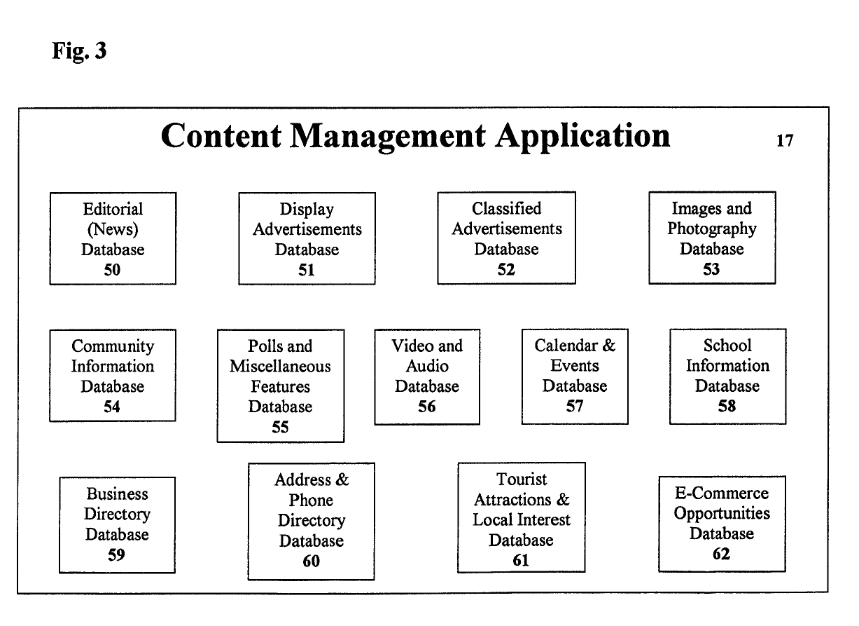

FIG. 3 shows the various database software elements of the Content Management Application 17. These software elements include editorial database 50, display advertisements database 51, classified advertisements database 52, images and photography database 53, community information database 54, polls and miscellaneous features database 55, video and audio database 56, calendar and events database 57, school information database 58, business directory database 59, address and phone directory database 60, tourist attractions and local interest database 61, and e-commerce opportunities database 62.

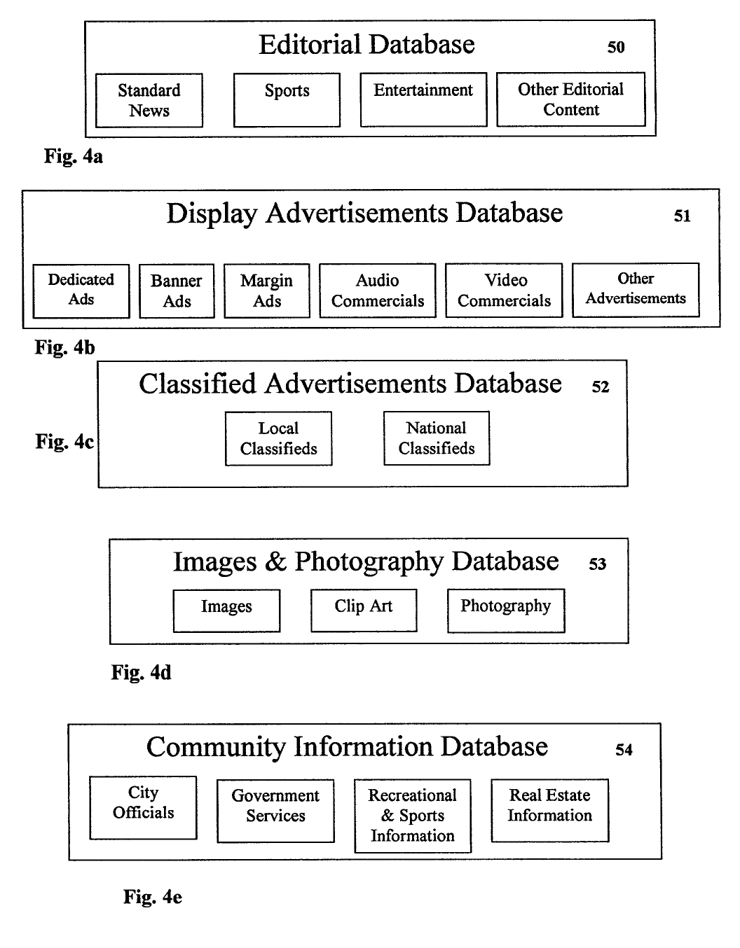

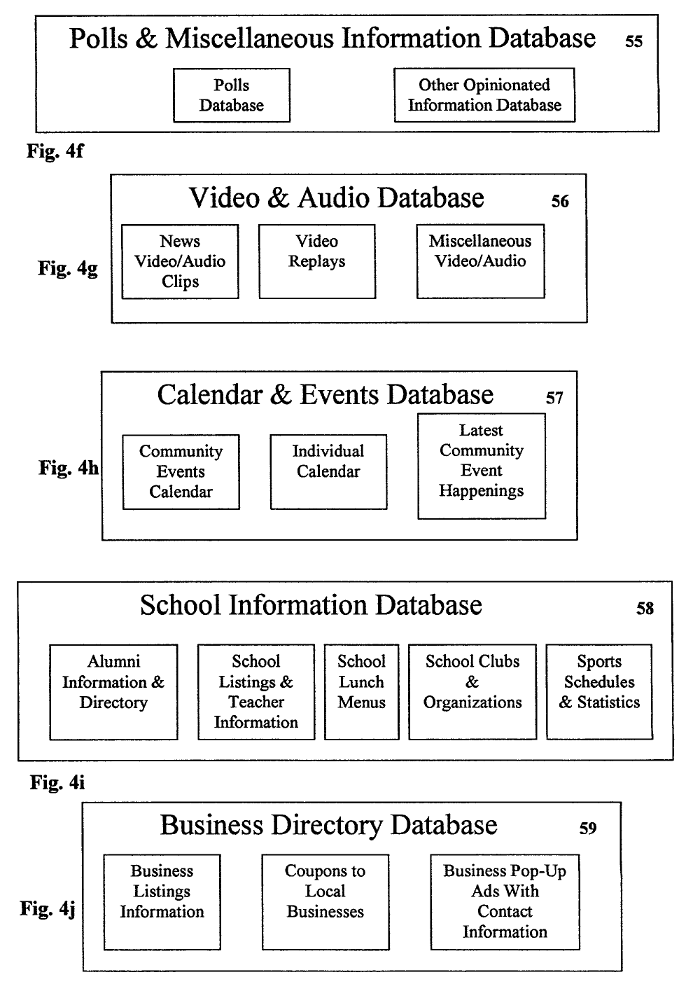

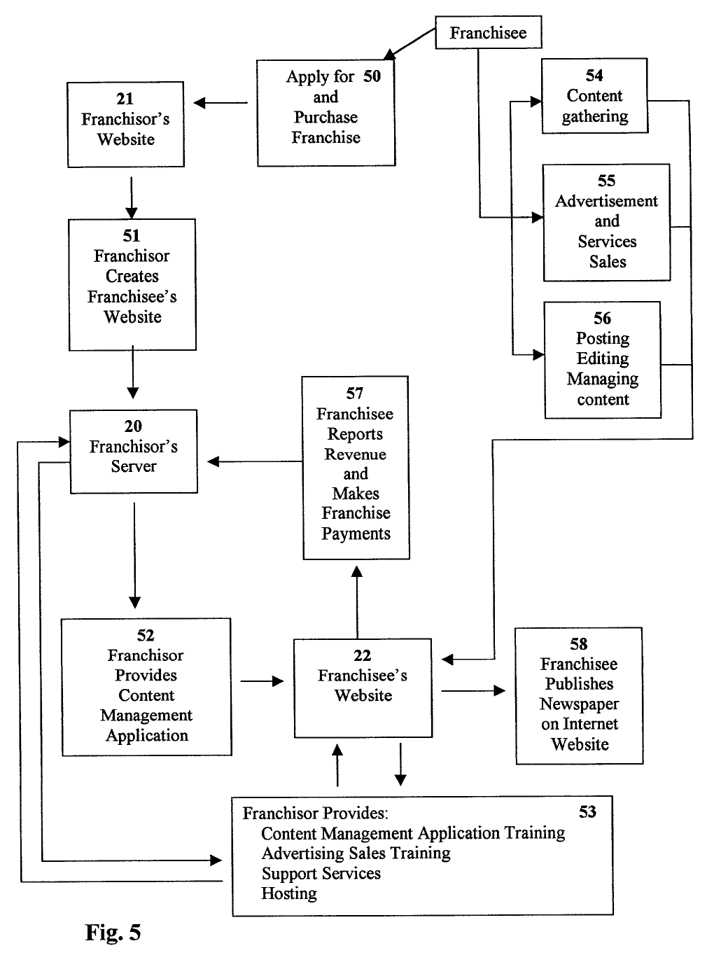

These database elements represent generic categories to which most news content will apply. Other categories may be created as desired, but these are the main marketable categories of established news publications. FIGS. 4a-j show the various subcategories of these database software elements.

Editorial database 50 (FIG. 4a) is the heart of the news gateway (website). This database is where all editorial content can be added, deleted, edited, and managed. From all genres of news stories, such as Headline News, Broadcasting News, Sports, Entertainment, Community News, Weather, etc., any type of editorial could take place in this portion of the Management Content Application.

The Display Advertisements Database 51 (FIG. 4b) manages all aspects of commercial advertisements, from adding, deleting, editing, and maintaining the advertisements. All uploads of pictures relative to the ads, actual links, and content of the ads would take place in this section of the application. All video and audio ads could also be added, deleted, edited, and maintained in this section.

The Classified Advertisement Database 52 (FIG. 4c) manages all classified advertisements, which can be added, deleted, edited, and maintained here. Also, uploading preexisting classified ads from another database, such as national classified ads, can be performed here.

The Images and Photography Database 53 (FIG. 4d) manages and maintains all images and photography. Any editing of the photograph or image could be performed using a standard picture editing program such as PhotoShop. Once the image or photo is uploaded to the database 53, that image or photo could be utilized within the website whenever a picture container is specified for that particular site.

The Community Information Database 54 (FIG. 4e) provides adding, deleting, editing, and managing all community information, such as, for example, farm information, fishing information, hunting information, city government information and services, etc. Polls and miscellaneous information data base 55 (FIG. 4f) provides opinion related information.

The Video and Audio Database 56 (FIG. 4g) provides for adding, deleting, editing and maintaining all video and audio content. Video and audio content can be uploaded from any source to this database and can be stored in this database permanently. This content, like all other content, such as editorial, can be archived for future use and research, and could even be offered for sale. Calendar and events database (FIG. 4h) provides time, place, and location of community events.

The School Information Database 58 (FIG. 4i) provides for adding, deleting, editing, and maintaining all content relating to schools. The content could include, for example, alumni information, listings of schools and teacher information, homework assignments, school lunch menus, clubs and organizations information, sport schedules and statistics, etc.

The Business Directory Database 59 (FIG. 4j) includes all information on businesses including, for example, a listing of business directories and valid coupons for participating local businesses. This database could provide for a “pop-up” window advertisement that displays basic information about a company, such as name, address, phone number, hours of operation, basic products and services, etc.

FIG. 5 shows the Internet-based Franchise System of the present invention. The Franchisor provides an Internet based website 21 that introduces the Internet based Franchise and allows a potential Franchisee to apply for and make payment arrangements for the Franchise 50. The application and payment data enter the Franchisor's server 20 via the Franchisor's website 21 (see FIGS. 1 and 2). The Franchisor then creates a website on the Internet for the Franchisee 51, using the Franchise website design application 34 in the website module 11 in Franchisor's computer 10 (see FIG. 2).

The entire custom design, custom layout, and architecture of the Franchisee's business model website is created by the Franchisor to meet the Franchisee's specifications. The website can also be built using existing templates. Some of the features of the Franchisee's designed website include, by way of example: local news, national news, world news, sports, entertainment, business, travel, education, schools, archives of past data, editorials, politics, community affairs, weather, classified ads (including national database), real estate portal, advertisements, health news, events, community calendars, e-mail functionality, e-commerce opportunities, video/audio files, message boards, chat rooms, photo gallery, special sections specific to each community, links to other relevant sites, and video cams.

The Franchisor then, using the Initialization Module 12 in Franchisor's computer 10 (see FIG. 2), provides to the Franchisee's website 22 the Content Management Application 17, the Content Management Application Training Application 31, and the Ad Sales Training Application 32 (steps 52 and 53). These can then be downloaded to the Franchisee's computer 16 or implemented directly on the Franchisee's website 22 providing in Franchisee's computer 16 Content Management Application 17 as a publication engine, training module 18, posting module 19, and reporting module 15. The Franchisee executes the training programs so that he or she is then prepared and trained to use the Content Management Application 17 to create his or her newspaper for publication on the Franchisor's website, and to solicit advertisements from advertisers to generate income for the publication of the newspaper on the Internet website.

The Content Management Application Training covers all aspects of the application, including adding, deleting, editing, and maintaining all content, including, but not limited to, editorial, advertising, photography, video, audio, classified ads, display ads, and uploading national advertisements from a national advertisement database provided by the Franchisor. Training also includes methods of recording audio and video, and making digital video commercials for display on the Franchisee's website.

The Advertising Sales Training provides text, audio, and video training materials via the Franchisor's computer and server which can be implemented on the website and downloaded. The training materials include methods and techniques for contacting and inviting advertisers, methods in displaying the website, newspaper, and ad placement, follow-up techniques, methods in closing the sale, and methods for generating repeat sales from existing customers. The training further includes methods for advertising the website to readers of the published newspaper.

The sustained function of the Franchisee's newspaper publication on the website 22 is maintained by the Franchisor using the Hosting Application 14 in Franchisor's computer 10 (Step 53). A host is a computer that acts as a server. On the Internet, a host has full two-way access to other computers on the Internet. The host provides services to do some smaller or less capable service or program, and answers requests for information. Hosting Application 14, acting via Franchisor's Server 20, maintains the posting of the Franchisee's newspaper on Franchisee's website 22.

The long term support and maintenance of the Franchisee's website 22 is performed by the Support Module 13 in the Franchisor's computer 10 via the Franchisor's server 20 and the Franchisee's website 22. These services include, for example, providing the latest and fastest communications network connectivity, e-mail service and maintenance, hardware replacement options, technical troubleshooting, routing of information, upgrades, programming services, national classified ad implementation, and national advertising implementation. The Franchisee can access all elements of training, services, and hosting directly from his or her website 22.

As the Franchisee conducts business, he or she will gather news content 54, sell advertisements and services 55 to be implemented on Franchisee's website 22, and edit, manage, and post the newspaper 56 on the website 22. The newspaper is then published on the Franchisee's Internet website 58. The revenue from sales can be reported to the Franchisor 57 from website 22 via server 20. The reporting activity is supported by Reporting Module 15 on Franchisor's computer 10 (see FIG. 2). The Franchisee is then billed for franchise payments by the Franchisor, and the billing can be sent to Franchisee's website 22. The Reporting Module 15 can also provide Franchisee accounting, record keeping, and an archiving system located on Franchisee's website 22 or computer 16, where the Franchisee can record, track, analyze, and retrieve financial activities of his or her newspaper publishing business. Finally the Franchisee makes payments to the Franchisor under the terms of the Franchise Agreement 57.

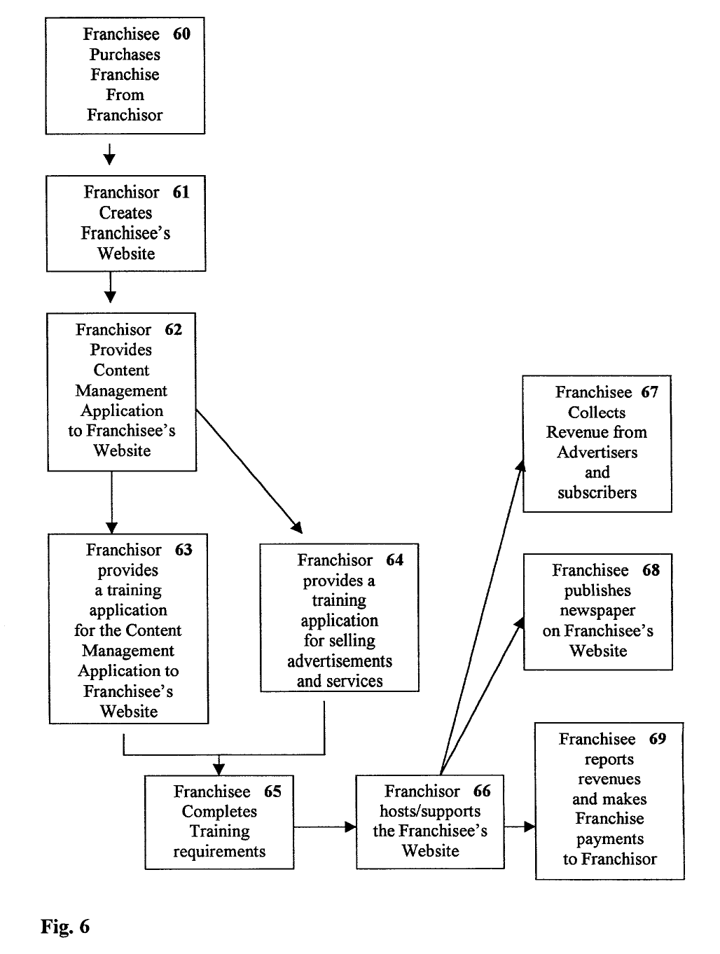

FIG. 6 shows the method of the present invention of franchising Internet based newspaper publishing. The franchisee contacts, applies for, and purchases the franchise from the Franchisor 60. The Franchisor creates the Franchisee's website interactively with the Franchisee once the website address is created on the Internet 61. The Franchisor then provides the Content Management Application (printing press) to the Franchisee's website for the Franchisee's use in creating the newspaper publication 62. The Franchisor then provides to the Franchisee's website training programs to teach the Franchisee how to use the Content Management Application and how to sell advertisements and other services to advertisers 63, and 64. The Franchisee participates in the training interactively on his or her website and/or by downloading the training programs to his or her computer 65. The training module 18 also contains suitable search engines, solution engines, and problem solving engines. As the Franchisee creates his or her newspaper, the Franchisor serves as a host to the Franchisee's website and provides all support necessary for the creation, posting, and publishing of the newspaper on the Franchisee's website 66. The support module 13 also contains suitable search engines, solution engines, and problem solving engines. The Franchisee then collects revenues from advertisers and subscribers 67, publishes the newspaper on the Internet website 68, and reports revenue to the Franchisor via the Franchisee website and makes franchise payments to the Franchisor 69.

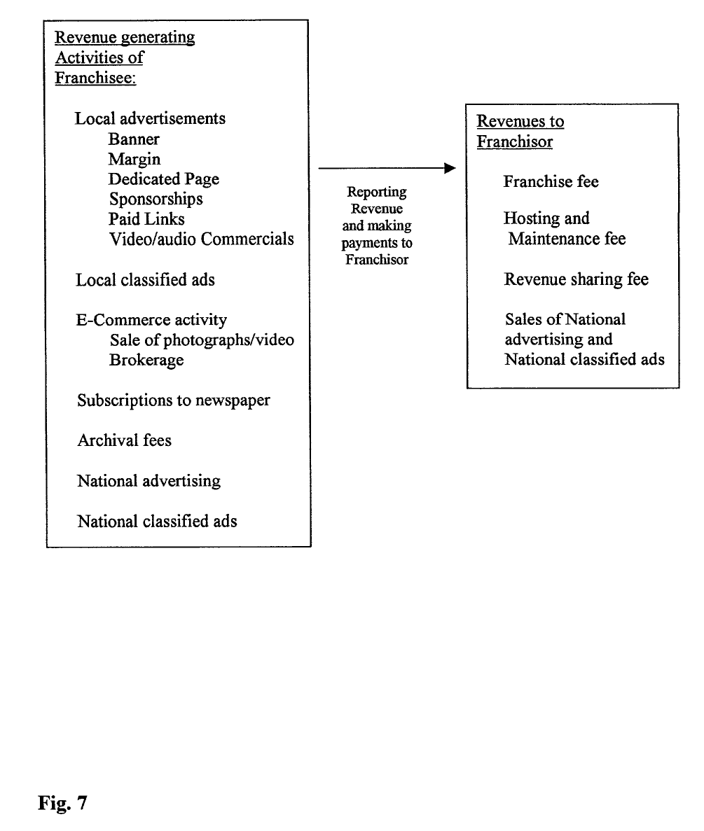

FIG. 7 shows the various revenue generating activities of the Franchisee supported by the Franchisor through the Content Management Application 17, the hosting Application 15, and the Support Module 35. 60%-75% of a Franchisee's total revenue could be generated from local advertising dollars. These advertisements could include, for example, banner advertisements, margin advertisements, dedicated page advertisements, sponsorships of sections of the news gateway (website), paid links and/or “pop-up” window advertisements, video/audio commercials (Webmercials), and any other form of advertising that would be relevant and an industry standard. The Franchisee could also generate revenue from the sale of classified advertisements to the general public and from businesses. The Franchisee could charge on the same basis as traditional newspapers, i.e. charge per word or per line and run time of the classified advertisement.

The Franchisee could participate in numerous e-commerce activities that are available currently and in the future. For example, the Franchisee could sell specific photographs and video clips that it captures during its reporting role to any interested party and/or patron of the business. The Franchisee could be involved in a brokerage activity, whereby he or she would take a percentage of any goods or services that are sold from posting of the advertisement of the goods and services. For example, if an individual bought a classified advertisement to be placed on the Franchisee's website to sell a car, the Franchisee could obtain 2% of the selling price.

The Franchisee could charge for access to its digital news and community gateway (website) and for his or her archived news information. Because all the content has been stored in an electronic database, this information is searchable and archived for future usage. This future usage, such as for research, could be fee-based or could require an annual archival fee.

The Franchisee's business could share in national advertising that is sold by the sales force of the Franchisor. This revenue could be tracked by counting the national advertisements that run on the Franchisee's website and how often they run. Once knowing this information, the Franchisor could pay the Franchisee a certain amount or percentage of the total national contract for that particular advertisement either on a monthly or quarterly basis.

The Franchisee's website being the community center for news and content, the Franchisee may partner with other local businesses. For example, an advertiser in the Franchisee's newspaper may want its own website and the Franchisee could refer the advertiser to the local web design shop. For this referral, the Franchisee could receive a referral fee.

The Franchisor shares in these Franchisee-generated revenues and also obtains revenues through fees associated with the franchise fee, hosting and maintenance fee, and sales of national advertising and national classified ads. Numerous methods of revenue generation could be established for the Franchisor. The franchise fee paid by the Franchisee to the Franchisor may be a one-time fee to purchase the rights and benefits of being a franchise owner. This franchisee fee could be paid as a lump sum or financed over a period of time with interest. This fee could cover a number of benefits and services such as the custom design and layout of the digital news source or site, the Database Content Application (the publishing means of the business), Content Management Application training, advertising sales training, sales literature, suggested office space layout and supplies, suggested business plan and strategy for the Franchisee, and corporate mailings and newsletters. The Hosting & Technical Maintenance Fee could be a monthly fee paid to the Franchisor to cover hosting of the digital news source (website hosting), technical upgrades, technical maintenance of digital news source, connectivity to the Internet, and other technical support. The Franchisee could pay this fee monthly which would eliminate the need of an Information Technology employee such as a Web Master.

Revenue sharing fees paid to the Franchisor by the Franchisee could be paid each month or quarter as a percentage of gross revenue or gross profits. The Franchisor may also offer subsequent training sessions for a fee, based on different issues facing the franchise business, such as the latest technology, additional training seminars, upgrade seminars, industry-specific seminars, sales seminars, etc. The Franchisor could have its own advertising sales force to sell national advertisements that could be placed on each Franchisee's website.

The Franchisor could also generate other e-commerce on a national level that could be shared with each Franchisee. This could be generated from a variety of products and services that currently exist today and for future products and services. Both the Franchisor and Franchisee could share in this revenue based on pre-determined percentages and the revenue could be shared on a monthly or quarterly basis.

The Franchisor can sell website redesign services to the Franchisee. This service would eliminate the need of a full staff Web Master and the costs associated therewith. Also, this would keep the Franchisee's presence new and maintain its lead in the marketplace. With the Franchisor being “in touch” with the current technology industry, he or she could provide the most efficient and best design and look for the newspaper franchise business. The present invention, thus, allows an individual to create his or her own newspaper, operate the newspaper as a profitable business, and compete effectively with established, large, corporate newspaper publishing entities.

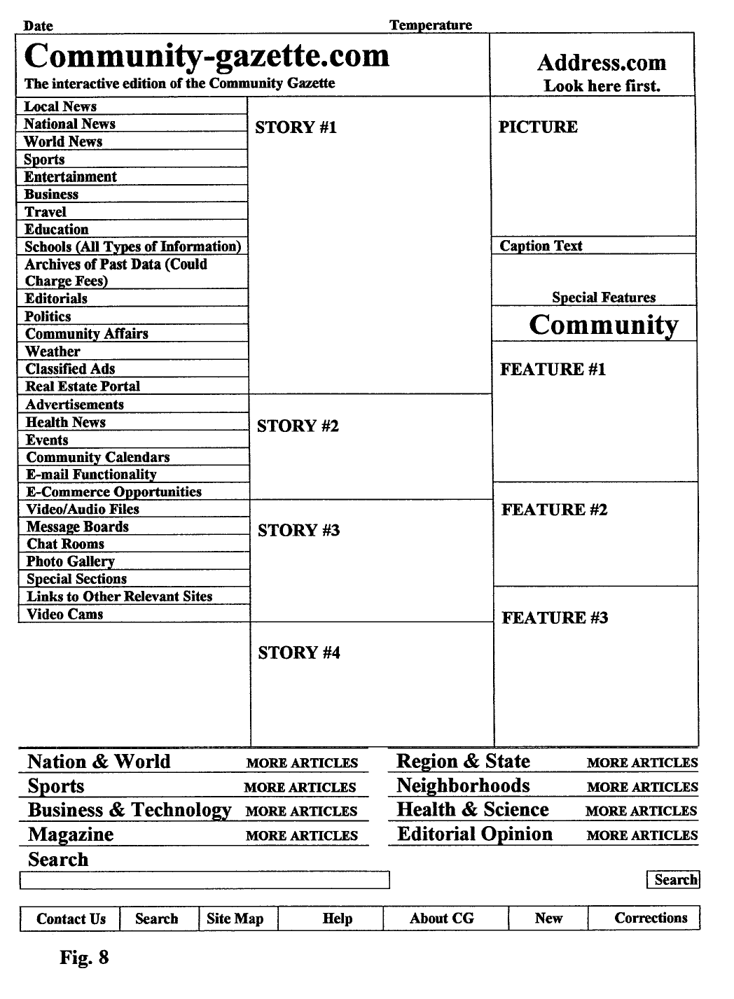

FIG. 8 illustrates, as an example, how a typical generic community newspaper may appear on an Internet website, displayed on a computer screen, by means of the system and/or method of the present invention.

Although this aspect of the present invention has been described with respect to the embodiments described and illustrated above, various alternatives may be used without departing from the scope of the invention. For example, although this embodiment uses the Internet for delivery of the website newspaper, other forms of communication links may be used, including newer forms that may be created in the future. Furthermore, magazines, periodicals, and other forms of visual communication and publications may be used, in addition to the newspaper. The Franchisee may choose not to charge a subscription fee. All information and applications downloaded to the Franchisee's website by the Franchisor can be downloaded to Franchisee's computer.

It will be understood that various changes in the details, materials, and arrangements of the parts which have been described and illustrated above in order to explain the nature of this invention may be made by those skilled in the art without departing from the principle and scope of the invention as recited in the following claims.

I claim:

1. A network-based publishing franchise system comprising:
a. a Franchisor server maintaining a Franchisor website on a communications system;
b. a Franchisor computer linked to said server and having an initiation module, a website module, a hosting application, a support module, and a reporting module;
c. said initiation module having a content management application, a content management application training application, and an ad sales training application;
d. a franchisee computer linked to said communication system and to said franchisor website;
e. said website module providing a franchisee website, said content management application providing a publication engine, and said hosting application maintaining said franchisee website, each from said franchisor computer through said server and said communication system; and
f. said initiation module providing to said franchisee website, and to said franchisee computer, said content management application, a training module, a posting module, and a reporting module, from said franchisor computer through said server and said communication system.

2. The system of claim 1 wherein said content management application provides an editing function and a publishing function for information content and for advertisements on said Franchisee website through said posting module.

3. The system of claim 2 wherein said advertisements include commercial advertisements and classified advertisements.

4. The system of claim 2 wherein said training module implements said Content Management Application Training Application and said Ad Sales Training Application on said Franchisee website and/or said Franchisee computer.

5. The system of claim 4 wherein said support module provides to said Franchisee website and said Franchisee computer technical support, upgrades, programming services, a national classified ad network system, and a national advertising system.

6. The system of claim 5 wherein said reporting module implements reporting revenues and making Franchise payments by a Franchisee to a Franchisor.

7. The system of claim 1 wherein said Content Management Application contains a plurality of databases providing news, advertisements, photography, community information, audio and video presentation, polls, events, school information, directories, tourist information, and E-commerce opportunities.

8. The system of claim 1 wherein said Franchisee website is linked to said Franchisor computer through said Franchisor server.

9. The system of claim 8 wherein said Franchisee website is linked to said Franchisor computer through said Franchisor website.

10. The system of claim 1 wherein the publishing Franchise is a newspaper Franchise.

11. A method of franchising network-based newspaper publishing, comprising:
a. providing to a Franchisor a computer, a server, and a website, said computer, server, and website linked by a communications network;
b. providing to a Franchisee a computer and a communications network;
c. providing the purchase of a network-based publishing franchise to a Franchisee through said Franchisor website;
d. creation of a Franchisee website by a Franchisor from said Franchisor computer through said server and communications link;
e. providing to said Franchisee website and Franchisee computer a Content Management Application having a publication engine, from said Franchisor computer through said server and said communications link;
f. providing to said Franchisee website and said Franchisee computer a training module for said Content Management Application and for selling advertisements and services, from said Franchisor computer through said server and said communications link;
g. completion by said Franchisee of training requirements;
h. hosting and supporting of said Franchisee website by the Franchisor from said Franchisor computer through said server and communications link;
i. publication by the Franchisee on said Franchisee website over said communication network; and
j. reporting revenues by the Franchisee to the Franchisor and making franchise payments by the Franchisee to to the Franchisor.

12. The method according to claim 11 wherein said Content Management Application provides an editing function and a publishing function for information content and advertisements on said Franchisee website through a posting module.

13. The method according to claim 12 wherein said training module further comprises a Content Management Application Training Application and an Ad Sales Training Application.

14. The method according to claim 13 wherein said hosting further provides maintaining said Franchisee website and posting publication by the Franchisee on said Franchisee website.

15. The method according to claim 14 wherein said supporting further provides technical support, upgrades, programming services, a national classified ad network system, and a national advertising system.

16. The method according to claim 15 wherein said reporting and making payments is provided by a reporting module.

17. The method according to claim 16 further comprising the step of collecting revenues by the Franchisee from advertisers.

18. The method of claim 17 wherein said Content Management Application contains a plurality of databases providing news, advertisements, photography, community information, audio and video presentations, polls, events, school information, directories, tourist information, and E-commerce opportunities.

19. The method according to claim 12 wherein said advertisements include commercial advertisements and classified advertisements.

20. The method according to claim 11 wherein the publishing is newspaper publishing.
